(19) United States
(12) Patent Application Publication
(10) Pub. No.: US 2011/0308954 A1
(43) Pub. Date: Dec. 22, 2011

(54) Gel excitation apparatus

(76) Inventors: Darius Kelly, Rancho Cucamonga, CA (US); Sean Gallagher, Claremont, CA (US)

(21) Appl. No.: 13/199,529

(22) Filed: Aug. 31, 2011

Related U.S. Application Data
(63) Continuation-in-part of application No. 12/316,182, filed on Dec. 9, 2008, now abandoned.

(51) Int. Cl. G01N 27/26

(52) U.S. Cl. 204/612

(57) ABSTRACT

A gel excitation apparatus for exciting a gel that includes a container for holding an aqueous solution within which the gel can be positioned, at least one light source disposed whereas the light path is perpendicular to the optical axis, the container for irradiating the gel with radiation within at least a first wavelength band, the first wavelength band selected to excite the gel to cause the gel to emit radiation into said aqueous solution. The aqueous core of the apparatus has a low refractive index, thus retaining the first wavelength band selected within said aqueous core to excite the gel. Thus, the aqueous core functions not only to increase the efficiency of excitation, but also increases the contrast between excitation light and sample emission light by retaining the light within said aqueous core.

### CROSS-REFERENCE TO RELATED APPLICATIONS

This is a Continuation-in-Part application of U.S. application Ser. No. 12/316,182 filed Dec. 9, 2008.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to the field of electrophoresis. More particularly, the invention concerns a novel gel excitation apparatus and the method of using the same for gel electrophoresis in which the apparatus includes an aqueous core having a low refractive index that increases the efficiency of excitation and the contrast between excitation light and sample emission light.

2. Description of Related Art Including Information Disclosed Under 37 CFR 1.97 and 1.98

Gel electrophoresis is a widely used technique for separating electrically charged molecules. In accordance with the technique, an electric field is generated to separate charged molecules that are suspended within a gel. The gel is typically a porous matrix generally comprising carbohydrate chains.

“Electrophoresis” refers to the electromotive force that is used to move the molecules through the gel matrix. By placing the molecules in the gel and applying an electric current, the molecules will move through the matrix at different rates, usually determined by mass. Molecules are pulled through the open spaces in the gel, but they are slowed down by the matrix based on their differing properties. The electrophoretic technique can analyze and purify a variety of bio-molecules, but is most frequently used to separate nucleic acids and proteins and is generally done in gels made of a porous insoluble material such as agarose or acrylamide.

After the electrophoresis is complete, the molecules in the gel can be stained to make them visible. The results of the process can then be analyzed quantitatively by visualizing the gel with monochromatic excitation light and a gel imaging device. The image can be recorded with a computer operated camera, and the intensity of the band or spot of interest is measured and compared against a standard or markers loaded on the same gel.

The U.S. patent to Foley et al., U.S. Pat. No. 5,936,730, concerns a bio-molecule analyzer including a plurality of test sites on a transparent substrate, each test site having probe molecules attached thereto. An array of addressable light sources is positioned in optical alignment with a corresponding test site. A solution containing sample molecules is positioned in contact with the plurality of test sites. A detector array having a plurality of photodetectors is positioned in optical alignment with the array of addressable light sources, one photodetector corresponding to each light source, and a light filter positioned between the detector array and the plurality of test sites for absorbing the light from the light sources and transmitting the light from the test sites to the detector array.

Unlike the apparatus of the present invention, the Foley et al. apparatus analyzes at the molecular level. Additionally, in Foley et al., the “solution” disclosed is merely a means of transporting the sample and is removed later in the process when the “sample” and “probe molecules” have bonded. Unlike the present invention, the solution is not used as a means of transferring the excitation light to the sample in a direction perpendicular to the optical axis.

U.S. Pat. No. 4,657,655 issued to Smoot et al. discloses a foto/phoresis apparatus for electrophoretically separating, visualizing and photographing DNA fragments in agarose gels. The apparatus, which combines an electrophoresis tank with a transilluminator includes an electrophoresis chamber having a platform and an electrode located on each side of the platform, a transilluminator having a UV light source, a frame defining a viewing opening over said light source, and a UV filtering cover for enclosing said viewing opening. The apparatus also includes a tray having movable gates for defining an enclosure for the agarose gel in one position and for locating the tray on the platform in the chamber in the other position, and a camera assembly adapted to be mounted on the frame in the transilluminator for providing 1:1 magnification photographs of the DNA fragment migration patterns. Unlike the apparatus of the present invention, the Smoot et al. device excites the sample with light emitted parallel to the viewing/optical axis, thus increasing background. Additionally, in Smoot et al. a running buffer (aqueous solution) is part of the electrophoresis process and has to be put into the tank when a gel is run. The aqueous solution is not added to enhance excitation or viewing contrast.

United States patent to Verma et al., U.S. Pat. No. 5,449,446, concerns a multi-purpose electrophoresis apparatus that comprises a laboratory electrophoresis apparatus that includes a gel casting platform permanently mounted in a buffer container with retractable dams on two opposite sides to retain the gel casting liquid prior to solidification. The gel remains in place on the platform and the dams are retracted for filling the buffer container and a vertical electric field is applied to compact the sample placed in the sample wells to the bottom. The electrophoresis in a horizontal direction is performed and may be observed by means of an included UV radiation source capable of causing the ethidium bromide treated molecular samples to emit visible light, which is observable through a UV opaque safety cover. A viewing hood including a UV cross-linking source may be substituted for viewing, especially during blotting or eluting operations, for which the gel is not moved from its casting platform. Like Smoot et al., in Verma et al. the transilluminator excites the sample with the light emitted parallel to the viewing/optical axis, thus increasing background. Additionally, in Verma et al. a running buffer (aqueous solution) is part of the electrophoresis process and has to be put into the tank when a gel is run. The aqueous solution is not added to enhance excitation or viewing contrast.

### BRIEF SUMMARY OF THE INVENTION

By way of brief summary, the gel excitation apparatus of the present invention for exciting a gel comprises a container for holding an aqueous solution within which the gel can be positioned; at least one light source disposed proximate the container for irradiating the gel with radiation within at least a first wavelength band, the first wavelength band selected to excite the gel to cause the stained protein or DNA within the gel to emit radiation; and a detector disposed above the container for monitoring radiation emitted from the stained protein of DNA within the gel.

With the forgoing in mind, it is an object of the present invention to provide a novel gel excitation apparatus and the method of using the same for gel electrophoresis in which the aqueous core of the apparatus functions not only to increase the efficiency of excitation, but also increases the contrast between excitation light and sample emission light.

Another object of the invention is to provide an apparatus of the character described in which the aqueous core comprises water.

Another object of the invention is to provide an apparatus of the character described in which the aqueous core comprises a gel running solution.

Another object of the invention is to provide an apparatus of the character described that includes a plurality of light sources disposed proximate the container for irradiating the gel with radiation within a wavelength band of between 254 and 900 nanometers.

Another object of the invention is to provide an apparatus of the character described in the preceding paragraph in which the plurality of light sources can be of identical, or different wavelengths.

Another object of the invention is to provide an apparatus of the character described in the preceding paragraphs in which the plurality of light sources can comprise light emitting diodes, fluorescent lamps, fiber optics, external electrode fluorescent lamps, cold cathode fluorescent lamps and the like.

### BRIEF DESCRIPTION OF THE DRAWINGS

FIG. 1 is a generally perspective view of one form of the apparatus of the invention.

FIG. 2 is an enlarged cross-sectional view taken along lines 2-2 of FIG. 1.

FIG. 3 is a generally perspective view of an alternate form of the apparatus of the invention.

FIG. 4 is an enlarged cross-sectional view taken along lines 4-4 of FIG. 3.

### DESCRIPTION OF THE INVENTION

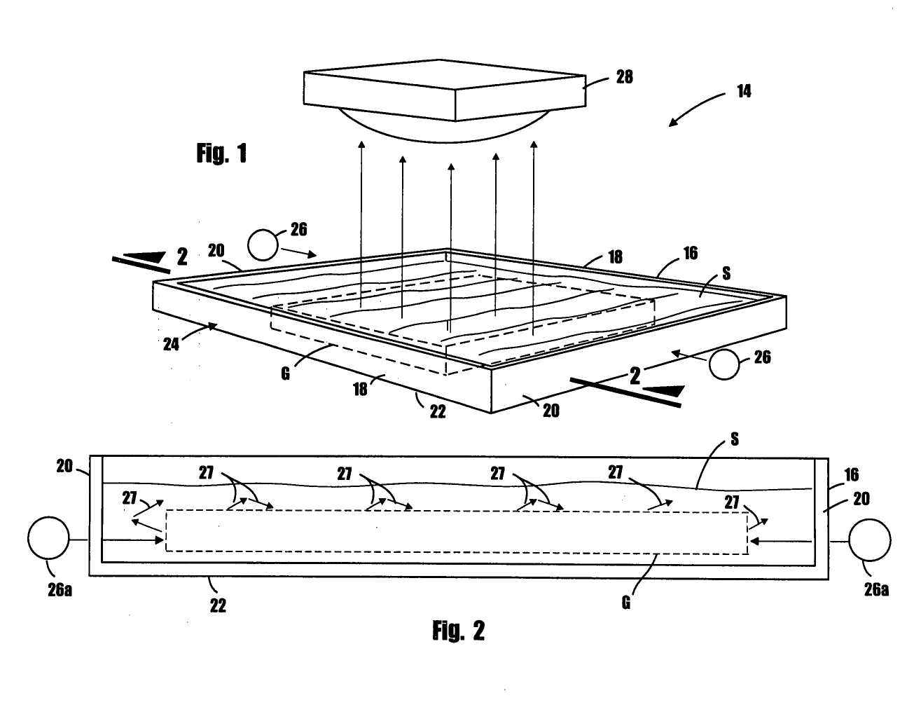

Referring to the drawings and particularly to FIGS. 1 and 2, one form of the gel excitation apparatus of the invention for exciting a gel is there shown and generally designated by the numeral 14. Apparatus 14 here comprises a container 16 for holding an aqueous solution “S”, here shown as water, within which a conventional electrophoresis gel “G” can be positioned in the manner shown in the drawings. Container 16 here comprises interconnected side, end and bottom walls 18, 20 and 22 respectively that cooperate to define a leak proof chamber 24, which holds the aqueous solution “S” and within which the gel “G” is positioned. Interconnected side, end and bottom walls 18, 20 and 22 can be formed of various materials, including glass, quartz, borafloat and like materials. In the present form of the invention, the walls are constructed from quartz.

A plurality of light sources 26 are disposed proximate to the container 16 for irradiating the gel with radiation within at least a first wavelength band that is selected to excite the gel “G” to cause the stained protein or DNA within the gel to emit radiation in the manner indicated by the arrows 27 in the drawings (FIG. 2). It is important to note that the aqueous solution acts as a “guide”, transferring the excitation light to the sample. Importantly, the excitation light is retained within the aqueous solution in a manner to minimize background radiation. The emission from the sample exits the aqueous solution to be imaged/visualized. As illustrated in the drawings, the optical axes from light sources 26 are substantially perpendicular to the excitation axes indicated by the vertical arrows in FIG. 1. With this construction, the excitation light generated by the light sources 26 is directed into the container along a plurality of first axes and the radiation emitted from the gel is emitted along a plurality of second axes that are generally perpendicular to the first axes.

Light sources 26 can be of various types well known to those skilled in the art, including light emitting diodes, fluorescent lamps, fiber optics, external electrode fluorescent lamps, cold cathode fluorescent lamps and the like. As previously mentioned, depending upon the experiments to be performed, light sources 26 can be of identical, or different wavelengths and can emit radiation within a wavelength band of between 254 and 800 nanometers. By way of example, the light sources 26a shown in FIG. 2 are positioned proximate the ends 20 of the container and comprise conventional fluorescent lamps.

As illustrated in FIG. 1, a conventional radiation detector 28 is disposed above container 16 for monitoring the radiation emitted from the aqueous solution “S”.

In carrying out one form of the method of the invention, energization of the light sources 26a will cause the gel “G” to be controllably irradiated at a selected wavelength band so as to excite the gel in a manner to cause the stained protein or DNA within the gel to emit radiation into said aqueous core solution, or water, within which the gel is disposed (see arrows 27 of FIG. 2). Uniquely, the aqueous core functions not only to increase the efficiency of the excitation finally detected by the detector 28, but also increases the contrast between excitation light and sample emission light.

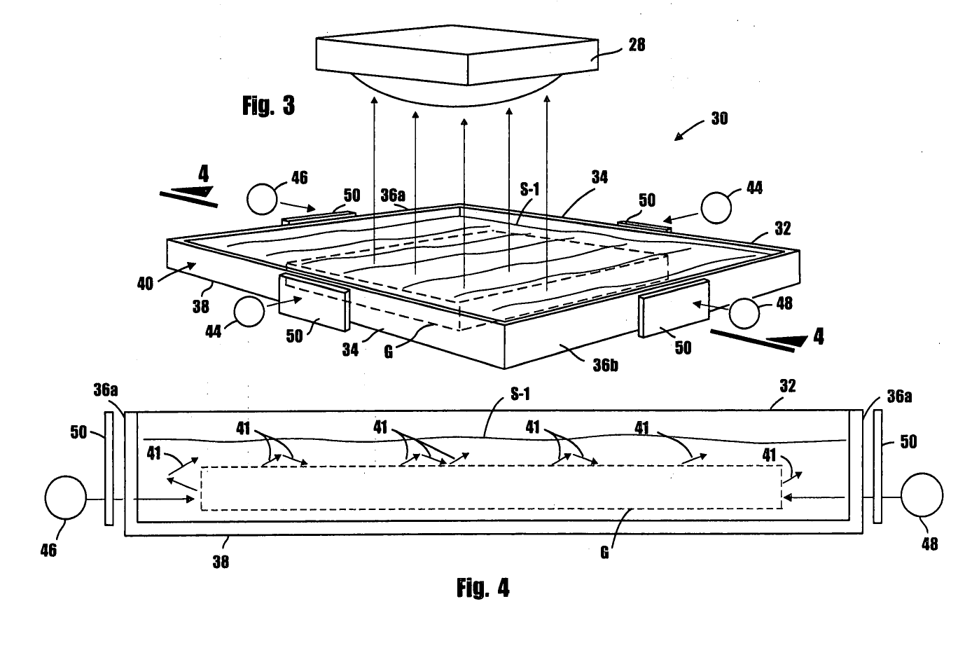

Referring next to FIGS. 3 and 4 of the drawings, an alternate form of the gel excitation apparatus of the invention for exciting a gel is there shown and generally designated by the numeral 30. Apparatus 30 is similar in many respects to apparatus 14 and like numerals are used in FIGS. 3 and 4 to identify like components. Apparatus 30 here comprises a container 32 for holding an aqueous solution, here shown as a gel running solution “S-1” within which a conventional electrophoresis gel “G” can be positioned in the manner shown in the drawings. Container 32 is similar in many respects to container 16 and here comprises interconnected side, end and bottom walls 34, 36a, 36b and 38 respectively that cooperate to define a leak proof chamber 40, which holds the aqueous solution “S-1” and within which the gel “G” is positioned. Walls 34, 36a, 36b and 38 are here constructed from glass.

As before, a plurality of light sources are disposed proximate to container 32 for irradiating the gel to cause the gel to emit radiation into an aqueous solution in the manner indicated by the arrows 41 in the drawings. In this latest form of the invention, light emitting diodes 44 are positioned proximate the sides 34 of the container, while an external electrode fluorescent lamp 46 is positioned proximate end 36a and a cold cathode fluorescent lamp 48 is positioned proximate end 36b. As shown in FIG. 4, the light emitting diodes 44 emit light into the container in a first direction.

A novel feature of this latest form of the invention is the provision of filters 50 between each of the light sources and the walls of the container. Filters 50 may be diffusing filters, absorbing filters, partially reflecting filters, and interference filters. More particularly, filters 50 may be used to control the wavelengths of the light irradiating the gel “G”. For example, filters 50 may be designed to pass the wavelengths necessary to excite the gel while absorbing or reflecting those wavelengths which are the same as those emitted by the gel. Filters 50 can also be designed to diffuse the light emitted by the light sources as well as control the intensity pattern of the emitted light.

As in the earlier described embodiment, a conventional radiation detector 28 is disposed above container 32 for monitoring the radiation emitted from the aqueous solution “S-1”. As clearly shown in FIG. 3 of the drawings, the radiation emitted from the aqueous solution is emitted in a second direction substantially perpendicular to the first direction in which light is emitted from diodes 44.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. A gel excitation apparatus for exciting the stained protein and DNA within a gel comprising:
(a) a container for holding an aqueous solution within which the gel can be positioned;
(b) at least one light source disposed proximate said container for generating excitation light for irradiating said gel with radiation within at least a first wavelength band, said first wavelength band selected to excite the gel to cause the gel to emit radiation, said excitation light being retained within said aqueous solution so as to minimize background radiation; and
(c) a detector disposed proximate said container for monitoring radiation emitted from said stained protein and DNA within said gel.

2. The apparatus as defined in claim 1, in which said light source comprises a fluorescent lamp.

3. The apparatus as defined in claim 1, in which said light source comprises a light emitting diode.

4. The apparatus as defined in claim 1, in which said light source comprises an external electrode fluorescent lamp.

5. The apparatus as defined in claim 1, in which said light source comprises a cold cathode fluorescent lamp.

6. The apparatus as defined in claim 1, in which said light source comprises a fiber optic.

7. The apparatus as defined in claim 1, in which said aqueous solution comprises water.

8. The apparatus as defined in claim 1, in which said aqueous solution comprises a gel running buffer.

9. The apparatus as defined in claim 1, in which a filter is associated with said at least one light source.

10. The apparatus as defined in claim 1, in which said filter is selected from the group consisting of diffusing filters, absorbing filters, partially reflecting filters, and interference filters.

11. A gel excitation apparatus for exciting the stained protein and DNA within a gel comprising:
(a) a container having interconnected side, end and bottom walls defining a leak proof chamber;
(b) an aqueous solution disposed within said leak proof chamber within which the gel can be positioned;
(c) a plurality of light sources located proximate said container for emitting excitation light into said container along a plurality of first axes for irradiating said gel with radiation within at least a first wavelength band, said first wavelength band selected to excite the gel to cause the gel to emit radiation, said excitation light being retained within said aqueous solution in a manner to minimize background radiation; and
(d) a detector disposed above said container for monitoring radiation emitted along a plurality of second axes generally perpendicular to said first axes from said stained protein and DNA within said gel.

12. The apparatus as defined in claim 11, in which said interconnected side and end walls are constructed from a light diffusing material.

13. The apparatus as defined in claim 11, in which said interconnected side and end walls are constructed from a light filtering material.

14. The apparatus as defined in claim 11, in which said plurality of light sources are selected from the group consisting of fluorescent lamps, light emitting diodes, external electrode fluorescent lamps and cold cathode fluorescent lamps.

15. The apparatus as defined in claim 11, in which at least one of said plurality of light sources comprises a fluorescent lamp.

16. The apparatus as defined in claim 11, in which said aqueous solution comprises water.
